(19) United States
(12) Patent Application Publication
(10) Pub. No.: US 2026/0058595 A1
(43) Pub. Date: Feb. 26, 2026

(54) MOTOR DRIVING APPARATUS AND ELECTRIFIED VEHICLE INCLUDING THE SAME

(71) Applicants: HYUNDAI MOTOR COMPANY, SEOUL (KR); KIA CORPORATION, SEOUL (KR); SEOUL NATIONAL UNIVERSITY R&DB FOUNDATION, SEOUL (KR)

(72) Inventors: Yoo Jong LEE, Hwaseong-si (KR); Ho Tae CHUN, Hwaseong-si (KR); Byung Kwan SON, Hwaseong-si (KR); Gyu Cheol LIM, Seoul (KR); Junhyuk YANG, Seoul (KR); Cheolmin HWANG, Seoul (KR); Jung-Ik HA, Seoul (KR)

(21) Appl. No.: 18/963,383

(22) Filed: Nov. 27, 2024

(30) Foreign Application Priority Data
Aug. 23, 2024 (KR) 10-2024-0113797

(51) Int. Cl. H02P 29/50; B60L 15/00; B60L 50/60; H02P 25/22

(52) U.S. Cl. CPC H02P 29/50; B60L 15/007; B60L 50/60; H02P 25/22

(57) ABSTRACT

Disclosed are a motor driving apparatus including a motor, a first inverter connected to a first DC terminal and the motor, a second inverter connected to the motor and a second DC terminal, and a ground line comprising a first node connected to the first DC terminal, a second node connected to the second DC terminal, a third node connected to a ground between the first node and the second node, and at least one impedance element provided thereon, and an electrified vehicle including the same.

### CROSS REFERENCE TO RELATED APPLICATION

The present application claims priority to Korean Patent Application No. 10-2024-0113797, filed Aug. 23, 2024, the entire contents of which is incorporated herein for all purposes by this reference.

### BACKGROUND

### Field

The present disclosure relates to a ground structure for a motor with dual voltage sources.

### Description of Related Art

With recent interest in the environment and vehicle impact on the environment, eco-friendly vehicles using an electric motor as a driving source have been increasing. The eco-friendly vehicle is also referred to as an electrified vehicle, representative examples of which includes hybrid vehicles (HEV) or electric vehicles (EV).

For small or light electric vehicles, cost competitiveness is of utmost importance, and it is thus important to reduce costs of not only high-voltage batteries but also power electronics (PE). Meanwhile, the most expensive component among high-voltage power electronic components is the high-voltage battery. To reduce the costs of the power electronics, it is required to lower the capacity of the high-voltage battery. However, when the capacity of the high-voltage battery is lowered, not only the driving range of the electric vehicle decreases, but also the outputs of a motor and an inverter decrease.

Thus, a motor driving system has been proposed to use a plurality of independent batteries as voltage sources. Such a motor drive system has a different circuit structure from that using a single battery as a voltage source.

Meanwhile, even in the motor driving sources using the plurality of independent batteries as the voltage sources, the ground is required to satisfy safety and environmental regulations. In particular, it is necessary to ground every battery as the plurality of batteries are connected.

Accordingly, there is a need to propose a new ground structure applicable to the motor driving system including the plurality of independent batteries as the voltage sources.

The foregoing matters described as the related art are only for enhancing the understanding of the background of the disclosure and should not be taken as an acknowledgement that they are the prior art already known to a person having ordinary skill in the art.

### SUMMARY

An aspect of the disclosure is to provide a motor driving apparatus, which has a ground structure that breaks leakage of zero sequence current when driving a motor with dual voltage sources, and an electrified vehicle including the same.

It should be noted that aspects of the disclosure are not limited to the above-mentioned aspect, and other aspects of the disclosure will be apparent to those skilled in the art from the following descriptions.

According to an embodiment of the disclosure, a motor driving apparatus includes: a motor including a plurality of windings; a first inverter including a first end connected to a first DC terminal, and a second end connected to a first end of the plurality of windings; a second inverter including a first end connected to a second end of the plurality of windings, and a second end connected to a second DC terminal; and a ground line including a first node connected to the first DC terminal, a second node connected to the second DC terminal, a third node connected to a ground between the first node and the second node, and at least one impedance element provided thereon.

For example, DC voltages may be applied to the first DC terminal and the second DC terminal, respectively.

For example, the first node may be connected between two poles of the first DC terminal, and the at least one impedance element may be provided between the first node and the two poles of the first DC terminal.

For example, the second node may be connected between two poles of the second DC terminal, and the at least one impedance element may be provided between the second node and the two poles of the second DC terminal.

For example, the at least one impedance element may be provided between the first node and the third node and between the second node and the third node.

For example, the at least one impedance element may be provided between the third node and the ground.

For example, the first node may be connected between the two poles of the first DC terminal, the second node may be connected between the two poles of the second DC terminal, and the at least one impedance element may be provided between the first node and the two poles of the first DC terminal and between the second node and the two poles of the second DC terminal.

For example, the at least one impedance element may be additionally provided in at least one of first positions between the first node and the third node and between the second node and the third node, and a second position between the third node and the ground.

For example, the at least one impedance element may form a resonance point in an avoidance frequency region where a zero sequence voltage of the motor has a preset level or less upon operating the motor.

For example, the avoidance frequency region may not overlap with a switching frequency region including a switching frequency for operating the motor, and a 3-harmonic frequency region including a 3-harmonic frequency for an electrical angle frequency of the motor.

For example, the avoidance frequency region may include a frequency region which has a higher frequency than the switching frequency region.

For example, the at least one impedance element may include a single element of either a capacitor or an inductor.

For example, the at least one impedance element may include a combination of a capacitor and an inductor.

For example, the at least one impedance element may generate a section where impedance increases between a plurality of resonance points on a frequency region upon operating the motor.

According to an embodiment of the disclosure, an electrified vehicle includes a motor including a plurality of windings, a first inverter including a first end connected to a first DC terminal, and a second end connected to a first end of the plurality of windings, a second inverter including a first end connected to a second end of the plurality of windings, and a second end connected to a second DC terminal, a ground line including a first node connected to the first DC terminal, a second node connected to the second DC terminal, a third node connected to a ground between the first node and the second node, and at least one impedance element provided thereon, and a first battery and a second battery connected to the first DC terminal and the second DC terminal, respectively.

According to various embodiments of the disclosure as described above, the ground structure corresponding to the motor driving system with the dual voltage sources is used to alleviate the leakage of the zero sequence components while satisfying ground requirements for each of the dual voltage sources.

It should be noted that effects of the disclosure are not limited to those described above and other effects of the disclosure will be apparent to those skilled in the art from the following description.

### BRIEF DESCRIPTION OF THE DRAWINGS

FIG. 1 shows the configuration of an electrified vehicle according to an embodiment of the disclosure.

FIG. 2 shows ground structures of a motor driving apparatus according to embodiments of the disclosure.

FIG. 3 shows ground structures of a motor driving apparatus according to embodiments of the disclosure.

FIG. 4 shows ground structures of a motor driving apparatus according to embodiments of the disclosure.

FIG. 5 shows an equivalent circuit of a ground structure according to an embodiment of the disclosure.

FIG. 6 describes design criteria of impedance elements according to embodiments of the disclosure.

FIG. 7 describes design criteria of impedance elements according to embodiments of the disclosure.

FIG. 8 describes design criteria of impedance elements according to embodiments of the disclosure.

### DETAILED DESCRIPTION

The structural or functional descriptions herein are merely illustrative for the purpose of describing embodiments of the disclosure with respect to various embodiments of the disclosure disclosed herein. Various embodiments of the disclosure may be implemented in various forms, and may not be construed as limited to the embodiments set forth herein.

The embodiments of the disclosure may be modified in various ways and have various embodiments, and thus specific embodiments will be illustrated by way of example in the accompanying drawings and described in detail. It should be understood, however, that the drawings and descriptions are not intended to limit the disclosure to the specific embodiments, but cover all modifications, equivalents, and alternatives that fall within the spirit and scope of the disclosure

Unless otherwise defined, all terms including technical and scientific terms used herein have the same meaning as commonly understood by a person of ordinary skill in the art to which the disclosure pertains. It will be further understood that terms defined in commonly used dictionaries should be interpreted as having a meaning consistent with their meaning in the context of the related art and will not be interpreted in an idealized or overly formal sense unless explicitly defined herein.

Hereinafter, embodiments of the disclosure will be described in detail with reference to the accompanying drawings, in which the same or similar elements are denoted by the same reference numerals even though they are depicted in different drawings and redundant descriptions thereof will be avoided.

In the following description of the embodiments, when a parameter is referred to as being “preset”, it may be intended to mean that a value of the parameter is determined in advance when the parameter is used in a process or an algorithm. The value of the parameter may be set when the process or the algorithm starts or may be set during a period that the process or the algorithm is executed.

Suffixes “module” and “unit” put after components in the following description are given in consideration of only ease of description and do not have meaning or functions discriminated from each other.

In terms of describing the embodiments of the disclosure, detailed descriptions of related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents and substitutions within the scope and spirit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

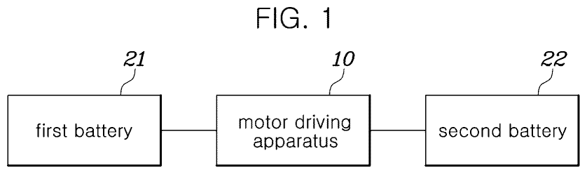

First, referring to FIGS. 1 to 5, the configuration of an electrified vehicle according to an embodiment of the disclosure will be described below.

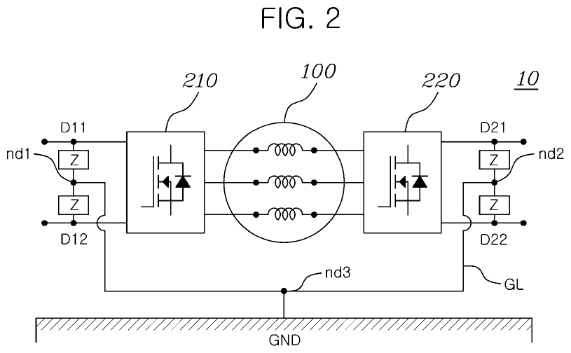

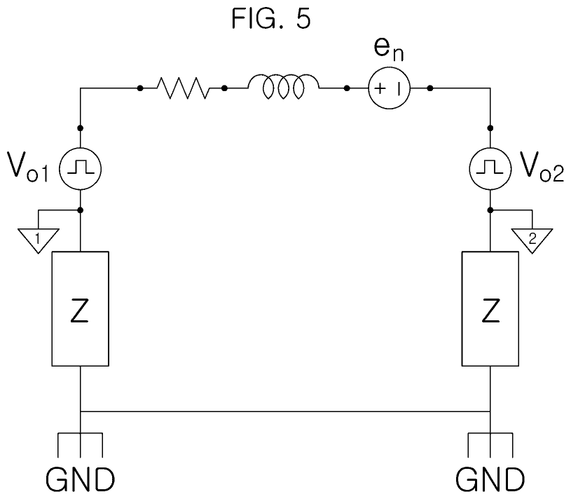

FIG. 1 shows the configuration of an electrified vehicle according to an embodiment of the disclosure, FIGS. 2 to 4 show ground structures of a motor driving apparatus according to embodiments of the disclosure, and FIG. 5 shows an equivalent circuit of a ground structure according to an embodiment of the disclosure.

Referring to FIGS. 1 to 5, the electrified vehicle according to an embodiment of the disclosure includes a motor driving apparatus 10, a first battery 21, and a second battery 22. However, FIG. 1 mainly shows components related to the description of embodiments, and an actual electrified vehicle may be implemented including more or fewer components than the components of FIG. 1.

First, the motor driving apparatus 10 includes a motor 100, a first inverter 210, a second inverter 220, and a ground line GL.

The motor 100 includes a plurality of windings, and the plurality of windings correspond to a plurality of phases, respectively. The first inverter 210 has a first end connected to first DC terminals D11 and D12, and a second end connected to a first end of the plurality of windings. The second inverter 220 has a first end connected to a second end of the plurality of windings, and a second end connected to second DC terminals D21 and D22. In other words, the motor driving apparatus according to an embodiment has a dual inverter structure where the plurality of inverters are connected to both ends of the motor 100, and thus the motor 100 is driven by the first inverter 210 and the second inverter 220.

DC voltages are applied to the first DC terminals D11 and D12 and the second DC terminals D21 and D22. The DC voltages may be provided by the first battery 21 and the second battery 22, respectively. To this end, the first battery 21 may be connected to the first DC terminals D11 and D12, and the second battery may be connected to the second DC terminals D21 and D22.

The ground line GL includes a first node nd1 connected to the first DC terminals D11 and D12, a second node nd2 connected to the second DC terminals D21 and D22, and a third node nd3 connected to the ground GND between the first node nd1 and the second node nd2. According to an embodiment, the ground GND may for example be a vehicle chassis, but is not limited thereto.

With this structure, the ground line GL connects the first DC terminals D11 and D12 and the second DC terminals D21 and D22, so that the first battery 21 connected to the first DC terminals D11 and D12 and the second battery 22 connected to the second DC terminals D21 and D22 can be connected to each other. Further, the first battery 21 and the second battery 22 are connected to the ground GND at once through the third node nd3 provided between the first node nd1 and the second node nd2.

Meanwhile, unlike the embodiments of the disclosure, a motor driving system based on a single voltage source allows a zero sequence current to flows through the insides of the motor and the inverter, thereby causing the ground circuit to have no effects on the flow of the zero sequence current. On the other hand, the ground circuit of the motor driving system based on the dual voltage sources in the electrified vehicle according to an embodiment may affect the flow of the zero sequence current when both the first battery 21 and the second battery 22 are connected as the dual voltage sources to the ground. In this case, a zero sequence circuit may be formed through the ground GND, and thus the zero sequence current may leak to the ground GND. In particular, when the vehicle chassis is used as the ground GND, it is necessary to prevent the zero sequence current from flowing to the ground GND because the zero sequence current may affect the safety of the vehicle and a vehicle user.

To this end, at least one impedance element Z may be arranged on the ground line GL, and such configuration and arrangement of the impedance element Z suppress the zero sequence current flowing to the ground GND. Below, a detailed configuration of the ground line GL for the impedance element Z will be described.

According to an embodiment, the first node nd1 is connected between two poles D11 and D12 of the first DC terminal, and at least one impedance element Z may be placed between the first node nd1 and the two poles D11 and D12 of the first DC terminal. In more detail, as shown in FIGS. 2 to 4, the impedance elements Z may be placed between the first pole D11 of the first DC terminal and the first node nd1 and between the second pole D12 of the first DC terminal and the first node nd1, respectively.

Further, the second node nd2 is connected between two poles D21 and D22 of the second DC terminal, and at least one impedance element Z may be placed between the second node nd2 and two poles D21 and D22 of the second DC terminal. In more detail, as shown in FIGS. 2 to 4, the impedance elements Z may be placed between the first pole D21 of the second DC terminal and the second node nd2 and between the second pole D22 of the second DC terminal and the second node nd2, respectively.

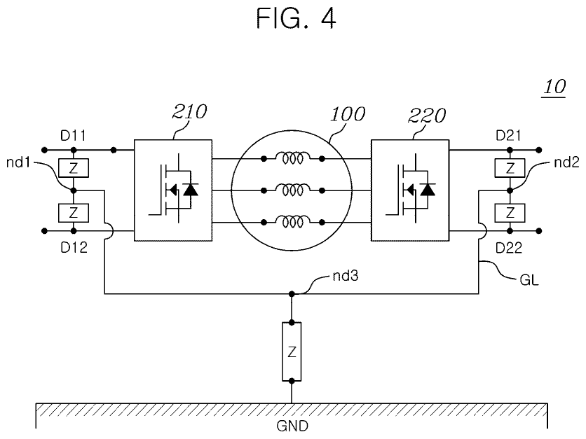

Besides, the at least one impedance element Z may be placed between the first node nd1 and the third node nd3 and between the second node nd2 and the third node nd3 as shown in FIG. 4, and may be placed between the third node nd3 and the ground GND as shown in FIG. 5.

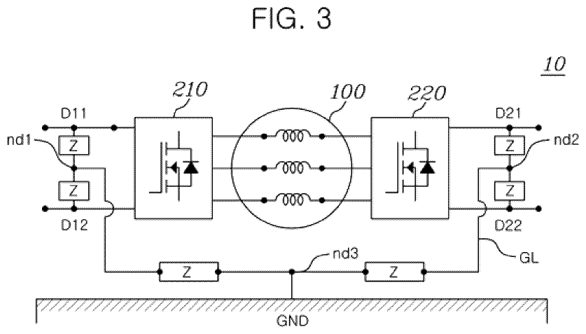

FIG. 2 shows a structure that the impedance elements Z are placed between the first node nd1 and the first DC terminals D11 and D12 and between the second node nd2 and the second DC terminals D21 and D22, FIG. 3 shows a structure that the impedance elements Z are further placed between the first node nd1 and the third node nd3 and between the second node nd2 and the third node nd3 as compared to FIG. 2, and FIG. 4 shows a structure that the impedance element Z is further placed between the third node nd3 and the ground GND as compared to FIG. 2. However, the ground structures applicable to the embodiments of the disclosure are not necessarily limited to those structures, and may for example be implemented by a combination of the structures shown in FIGS. 3 and 4 for placing the impedance elements Z.

Meanwhile, FIG. 5 shows an equivalent circuit of the foregoing ground structure of the motor driving apparatus 10 according to an embodiment and the electrified vehicle including the same.

More specifically, FIG. 5 shows the equivalent circuit corresponding to the ground structure of FIG. 1, and a zero sequence voltage eₙ of the motor 100, a zero sequence voltage V₀₁ of the first inverter 210, and a zero sequence voltage V₀₂ of the second inverter 220 on the equivalent circuit may serve as voltage sources of the zero sequence circuit. Further, resonance may occur on this equivalent circuit due to the inductance based on the plurality of windings in the motor 100, and the inductance and the capacitance of the impedance element Z.

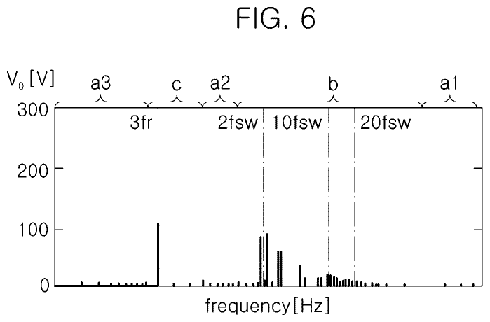

Here, the level of the zero sequence current flowing in the ground GND may be varied depending on where and how a resonance point, at which the resonance occurs due to the minimum zero sequence impedance as the maximum alternating current flows on the circuit, is formed in a frequency domain. The formation of the resonance point may be controlled based on the configuration of the impedance element Z. Below, the configuration of the impedance element Z for suppressing the zero sequence current will be described with reference to FIGS. 6 to 8.

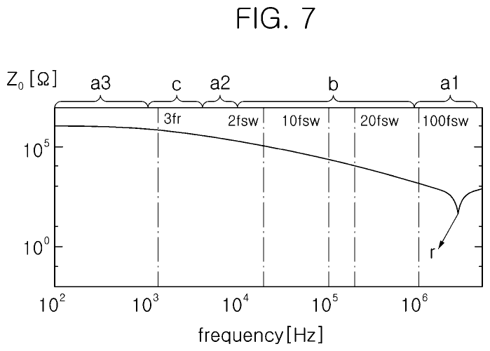

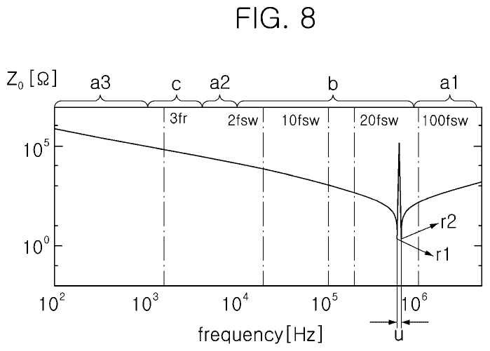

FIGS. 6 to 8 describe design criteria of impedance elements according to embodiments of the disclosure. FIG. 6 is a graph with the frequency and the zero sequence voltage, and FIGS. 7 and 8 are graphs with the frequency and the zero sequence impedance.

According to an embodiment, at least one impedance element Z placed on the ground line GL may be selected so that the resonance point can be formed in an avoidance frequency region where the zero sequence voltage of the motor 100 has a preset level or less when the motor 100 is operating.

Here, the zero sequence voltage generated when the motor 100 is operating may be varied depending on the operating speed, output torque, switching frequency, etc. of the motor 100, and therefore the preset level of the zero sequence voltage may be based on the operating conditions of the motor 100 and the driving conditions of the first inverter 210 and the second inverter 220. For example, the preset level of the zero sequence voltage may be varied depending on the specifications of the motor 100, the first inverter 210, and the second inverter 220 applied to the vehicle models or vehicles.

Meanwhile, the avoidance frequency region may refer to regions a1, a2, and a3, which do not overlap with a switching frequency region b including a switching frequency nfsw for driving the motor 100, and a 3-harmonic frequency region c including a 3-harmonic frequency 3 fr for an electrical angle frequency of the motor 100.

In particular, according to an embodiment, the avoidance frequency region may be a frequency region a1 in which frequencies are higher than that of the switching frequency region b as shown in FIG. 7. In this case, the resonance point r is formed in the frequency region where the zero sequence voltage components are relatively small, thereby suppressing the level of the zero sequence current.

To this end, the impedance element Z may be configured as a single passive element, for example, one of a capacitor and an inductor. In other words, according to an embodiment, the impedance element Z is configured as the single passive element, so that the resonance point can be formed in the avoidance frequency region, thereby determining the capacity of the element forming the impedance element Z in consideration of the switching frequency region b and the 3-harmonic frequency region c.

In addition, the impedance element Z may be configured by a combination of the capacitor and the inductor. In this case, the combination of the capacitor and the inductor may be implemented in various ways based on series and parallel connections. In this way, when the impedance element Z is configured by a combination of a plurality of elements, it is possible to control the impedance at the resonance point, the example of which is shown in FIG. 8.

Referring to FIG. 8, the impedance element Z is configured by a combination of a plurality of elements, thereby generating a section u where the impedance increases between a plurality of resonance points r1 and r2 when the motor 100 is operating. Here, the plurality of resonance points r1 and r2 is not necessarily referred to as a point where the impedance is exactly the minimum, but may include points where the impedance is close to the minimum on the entire frequency region. By using the impedance element Z to form the section u where the impedance increases between the resonance points r1 and r2, the impedance is relatively increased at the resonance points r1 and r2, thereby decreasing the level of the zero-phase current accordingly.

Through the ground structure corresponding to the motor driving system with the dual voltage sources according to various aforementioned embodiments of the disclosure, ground requirements for each of the dual voltage sources are satisfied, and the leakage of the zero sequence components is alleviated.

Although specific embodiments of the disclosure have been illustrated and described as above, various modifications and changes can be made by a person having ordinary knowledge in the art without departing from the scope of technical ideas defined by the appended claims.

What is claimed is:

1. A motor driving apparatus comprising:
a motor including a plurality of windings;
a first inverter including a first end connected to a first DC terminal, and a second end connected to a first end of the plurality of windings;
a second inverter including a first end connected to a second end of the plurality of windings, and a second end connected to a second DC terminal; and
a ground line including a first node connected to the first DC terminal, a second node connected to the second DC terminal, a third node connected to a ground between the first node and the second node, and at least one impedance element provided thereon.

2. The motor driving apparatus of claim 1, wherein DC voltages are applied to the first DC terminal and the second DC terminal, respectively.

3. The motor driving apparatus of claim 1, wherein
the first node is connected between two poles of the first DC terminal, and
the at least one impedance element is provided between the first node and the two poles of the first DC terminal.

4. The motor driving apparatus of claim 1, wherein
the second node is connected between two poles of the second DC terminal, and
the at least one impedance element is provided between the second node and the two poles of the second DC terminal.

5. The motor driving apparatus of claim 1, wherein the at least one impedance element is provided between the first node and the third node and between the second node and the third node.

6. The motor driving apparatus of claim 1, wherein the at least one impedance element is provided between the third node and the ground.

7. The motor driving apparatus of claim 1, wherein
the first node is connected between the two poles of the first DC terminal,
the second node is connected between the two poles of the second DC terminal, and
the at least one impedance element is provided between the first node and the two poles of the first DC terminal and between the second node and the two poles of the second DC terminal.

8. The motor driving apparatus of claim 7, wherein the at least one impedance element is additionally provided in at least one of a first positions between the first node and the third node and between the second node and the third node, and a second position between the third node and the ground.

9. The motor driving apparatus of claim 1, wherein the at least one impedance element forms a resonance point in an avoidance frequency region where a zero sequence voltage of the motor has a preset level or less upon operating the motor.

10. The motor driving apparatus of claim 9, wherein the avoidance frequency region does not overlap with a switching frequency region including a switching frequency operating the motor, and a 3-harmonic frequency region including a 3-harmonic frequency for an electrical angle frequency of the motor.

11. The motor driving apparatus of claim 10, wherein the avoidance frequency region is a frequency region which has a higher frequency than the switching frequency region.

12. The motor driving apparatus of claim 9, wherein each of the at least one impedance element is a single element of either a capacitor or an inductor.

13. The motor driving apparatus of claim 9, wherein each of the at least one impedance element is a combination of a capacitor and an inductor.

14. The motor driving apparatus of claim 13, wherein the at least one impedance element generates a section where impedance increases between a plurality of resonance points on a frequency domain upon operating the motor.

15. An electrified vehicle comprising:
a motor including a plurality of windings;
a first inverter including a first end connected to a first DC terminal, and a second end connected to a first end of the plurality of windings;
a second inverter including a first end connected to a second end of the plurality of windings, and a second end connected to a second DC terminal;
a ground line including a first node connected to the first DC terminal, a second node connected to the second DC terminal, a third node connected to a ground between the first node and the second node, and at least one impedance element provided thereon; and
a first battery and a second battery connected to the first DC terminal and the second DC terminal, respectively.
